(19) United States
(12) Patent Application Publication
(10) Pub. No.: US 2010/0177118 A1
(43) Pub. Date: Jul. 15, 2010

(54) PATH CREATION UTILITY FOR IMAGE EDITOR

(76) Inventors: Vadim Vasilievich SYTNIKOV, Moscow (RU); Sergey Evgenievich Gromov, Moscow (RU); Darryl R. Kuhn, La Jolla, CA (US); Justin B. Fiedler, San Francisco, CA (US)

Correspondence Address: FITCH EVEN TABIN & FLANNERY, 120 SOUTH LASALLE STREET, SUITE 1600, CHICAGO, IL, 60603-3406, US

(21) Appl. No.: 12/684,781

(22) Filed: Jan. 8, 2010

Related U.S. Application Data
(60) Provisional application No. 61/143,741, filed on Jan. 9, 2009.

(51) Int. Cl. G09G 5/00

(52) U.S. Cl. 345/619

(57) ABSTRACT

Methods and apparatus for a path-creation utility for use within an image editor. In some embodiments, the image editor enables a user to create customized image content by overlaying one or more images (for example, text, shapes, icons, etc.) upon one or more background images. Once the user is satisfied with the appearance of the created image, the user may then utilize the disclosed path creation utility to trace one or more paths around certain portions of the image. The traced paths may be used to effectively mask out undesirable content from the source image, or to otherwise enable the user to define a particular geometry for the image. The paths specified by the user may then be provided as input to an image cutting tool adapted to create an image with dimensions based upon the paths traced by the user.

### RELATED APPLICATIONS

This application claims priority to U.S. Provisional Patent Application Ser. No. 61/143,741, filed on Jan. 9, 2009, the content of which is incorporated by reference herein.

### FIELD OF THE INVENTION

The present invention relates generally to the field of image customization. More particularly, the present invention is directed in one exemplary aspect to enabling a user to create customized cut paths for a designated image.

### BACKGROUND OF THE INVENTION

A wide variety of image designs can be printed upon a substrate in order to enhance the aesthetic appeal or denote ownership of a particular venue, vehicle, or item. For example, a sports fan may wish to place a sticker bearing the logo of his favorite sports team upon an electronic device, upon an office or bedroom wall, or upon the side or window of his automobile.

In conventional technologies, however, a prospective purchaser of a printed substrate would be limited to selecting among a predetermined set of images, thus significantly restricting the purchaser's choices with respect to image content. Additionally, the purchaser would be precluded from utilizing image geometries other than the one geometry that had been predetermined for the image which he had selected.

What is needed is a means or mechanism for enabling an individual to create customized cut-paths for a particular image. Also, the paths created by the user should be readily scalable to support large and small image formats.

### SUMMARY OF THE INVENTION

Several embodiments of the present invention are directed to a path-creation utility for an image editor. The path creation utility may be used for tracing one or more paths around certain regions of an image. The paths specified by the user may then be provided as input to an image cutting tool which can create an image having dimensions based on the traced paths.

In a first aspect of the invention, an apparatus for defining a cut-path within a designated image is disclosed. In one embodiment, the apparatus comprises: a memory unit adapted to store a set of instructions; a processor connected to the memory unit and adapted to execute the set of instructions stored within the memory unit; a first module in communication with the memory unit and adapted to determine a next point within a cut-path; and a second module in communication with the memory unit and adapted to generate a path from a previous point in the cut-path to the next point in the cut-path, wherein the path generated is based at least in part upon a path map, and wherein the path map indicates, for each of a plurality of pixels represented within the path map, a specified direction from each respective pixel to the next point in the cut-path.

In a second aspect of the invention, an apparatus for enabling a remote device to define a cut-path within a designated image is disclosed. In one embodiment, the apparatus comprises: a memory unit adapted to store a set of instructions; a processor connected to the memory unit and adapted to execute the set of instructions stored within the memory unit; a communication module connected to the memory unit and adapted to transmit a requested image to the remote device; and a first module in communication with the memory unit and adapted to generate a cost map for the requested image, wherein the cost map indicates, for each of a plurality of pixels contained within the requested image, costs of traversing from each respective pixel to each of its neighboring pixels.

In a third aspect of the invention, a method for enabling a client device to define a cut-path within a designated image is disclosed. In one embodiment, the method comprises: receiving a first set of data from the client device, the first set of data adapted to indicate a designated image; generating a cost map for the designated image, wherein the cost map is adapted to indicate, per each pixel of the designated image, a cost for each pixel of a set of neighboring pixels; receiving a second set of data from the client device, the second set of data adapted to indicate a location of a current anchor point; creating a path map based at least in part upon the location of the current anchor point and the cost map, wherein the path map is adapted to indicate a path between the current anchor point and a previous anchor point; and transmitting the path map to the client device.

In a fourth aspect of the invention, a computer-readable medium for use in a client device is disclosed. In one embodiment, the computer-readable medium comprises instructions which, when executed by the client device, performs a process comprising: transmitting an identifier to a host device, wherein the identifier is adapted to indicate a selected image; receiving the selected image from the host device; determining a location of a current anchor point from a first input; transmitting the location of the current anchor point to the host device; receiving a path map from the host device, wherein the path map is adapted to indicate, for each of a plurality of pixels represented within the path map, a specified direction from each respective pixel to the next point in a path leading to current anchor point; and generating a path from a previous anchor point to the current anchor point based at least in part upon the path map.

### BRIEF DESCRIPTION OF THE DRAWINGS

FIG. 1A is a screen capture of a source image as presented by an exemplary image customization utility according to one embodiment of the present invention.

FIG. 1B is a screen capture of a region of the source image depicted in FIG. 1A, the region having a center at a user-defined anchor point according to one embodiment of the present invention.

FIG. 1C is a screen capture of the source image depicted in FIG. 1A, the source image having both a selected region and a masked region according to one embodiment of the present invention.

FIG. 2 is a block diagram of an exemplary client device configured for use with the path creation utility according to one embodiment of the present invention.

FIG. 3 is a flow diagram illustrating an exemplary method of generating a user-defined cut-path according to one embodiment of the present invention.

FIG. 4 is a flow diagram illustrating an exemplary process for generating a cost map according to one embodiment of the present invention.

FIG. 5 is a flow diagram illustrating an exemplary process for calculating an optimal path between two points according to one embodiment of the present invention.

FIG. 6 is a flow diagram illustrating an exemplary process for reducing the incidence of peaking within a path according to one embodiment of the present invention.

FIG. 7 is a flow diagram illustrating an exemplary process for Bezier curve generation for use in determining an optimal path according to one embodiment of the present invention.

FIG. 8 is a sequence diagram illustrating an exemplary sequence for generating a user-defined cut-path using a network application according to one embodiment of the present invention.

FIG. 9 is a flow diagram illustrating an exemplary process of creating a printed substrate having dimensions based upon one or more provided cut-paths according to one embodiment of the present invention.

### DETAILED DESCRIPTION OF THE EXEMPLARY EMBODIMENTS

In the following description of preferred embodiments, reference is made to the accompanying drawings which form a part hereof, and in which it is shown by way of illustration specific embodiments in which the invention may be practiced. It is to be understood that other embodiments may be utilized and structural changes may be made without departing from the scope of the preferred embodiments of the present invention.

As used herein, the term “anchor point” refers to a point fixed in a two-dimensional space that is represented by (x, y) coordinates.

As used herein, the term “Bezier Curve” refers to a curve whose shape is defined by anchor points set along its arc.

As used herein, the terms “application”, “computer program”, “program” and “software”, include without limitation any sequence of human or machine cognizable steps that are adapted to be processed by a computer. Such may be rendered in any programming language or environment including, for example, C/C++, Fortran, COBOL, PASCAL, Perl, Prolog, assembly language, scripting languages, markup languages (e.g., HTML, SGML, XML, VoXML), functional languages (e.g., APL, Erlang, Haskell, Lisp, ML, F# and Scheme), as well as object-oriented environments such as the Common Object Request Broker Architecture (CORBA), Java™ (including J2ME, Java Beans, etc.).

As used herein, the term “display” includes any type of device adapted to display information, including without limitation cathode ray tube displays (CRTs), liquid crystal displays (LCDs), thin film transistor displays (TFTs), digital light processor displays (DLPs), plasma displays, light emitting diodes (LEDs) or diode arrays, incandescent devices, and fluorescent devices. Display devices may also include less dynamic devices such as printers, e-ink devices, and other similar structures.

As used herein, the term “large format” refers to a classification of size exceeding 2″×2″.

As used herein, the term “mask” refers to image data which represents areas of an image to hide or expose.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), and PSRAM.

As used herein, the term “module” refers to any combination of software, firmware, or hardware that may be used to perform a designated function. While various modules may be described as discrete modules throughout the specification, one of ordinary skill in the art will appreciate that multiple modules may be combined to form a single module according to various embodiments of the invention.

As used herein, the term “negative space” refers to an area of an image defined by a path which is to be discarded.

As used herein, the term “network” refers generally to any type of telecommunications or data network including, without limitation, cable networks, satellite networks, optical networks, cellular networks, and bus networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, hybrid fiber coaxial, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, TCP/IP, H.323, etc.).

As used herein, the term “path” refers to a mathematically defined line or curve consisting of at least two anchor points.

As used herein, the terms “processor,” “microprocessor,” and “digital processor” refer to all types of digital processing devices including, without limitation, digital signal processors (DSPs), reduced instruction set computers (RISC), general-purpose (CISC) processors, microprocessors, gate arrays (e.g., FPGAs), programmable logic devices (PLDs), reconfigurable compute fabrics (RCFs), array processors, and application-specific integrated circuits (ASICs). Such processors may be contained on a single unitary IC die, or distributed across multiple components.

As used herein, the term “positive space” refers to an area of an image defined by a path which is to be kept.

As used herein, the terms “server” and “host device” include without limitation any computerized component, system or entity (regardless of form) which is adapted to provide data, files, applications, content, or other services to one or more other devices or entities on a computer network.

As used herein, the term “view port” refers to the window displaying image data as shown within the image editor.

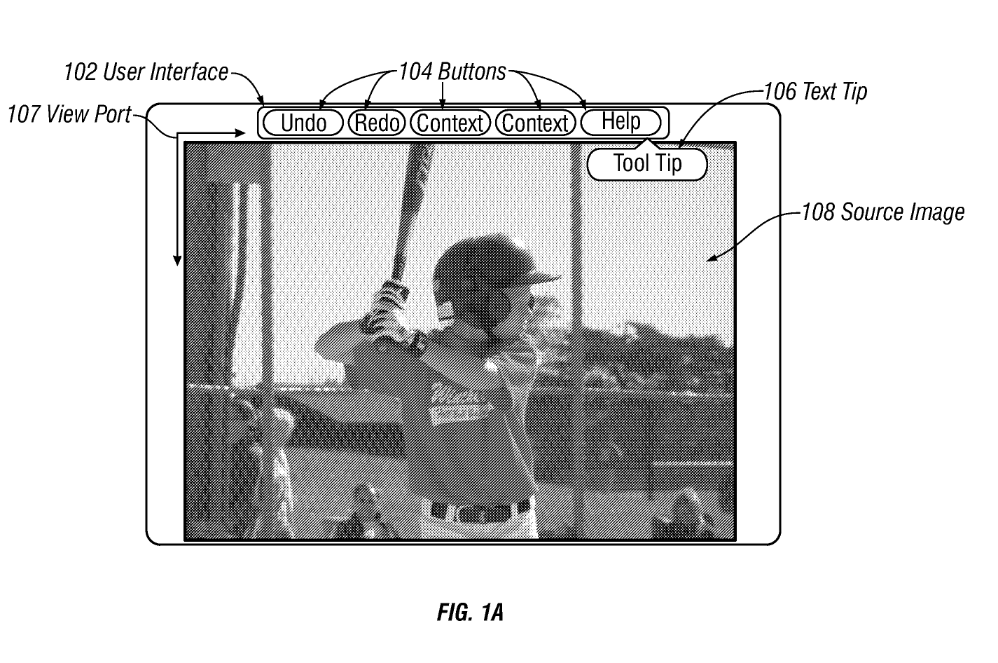

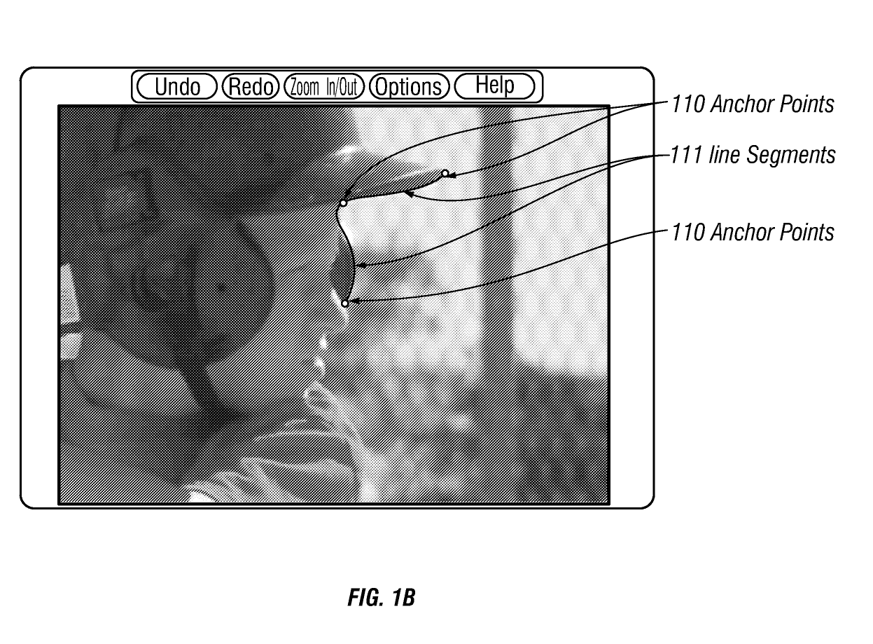

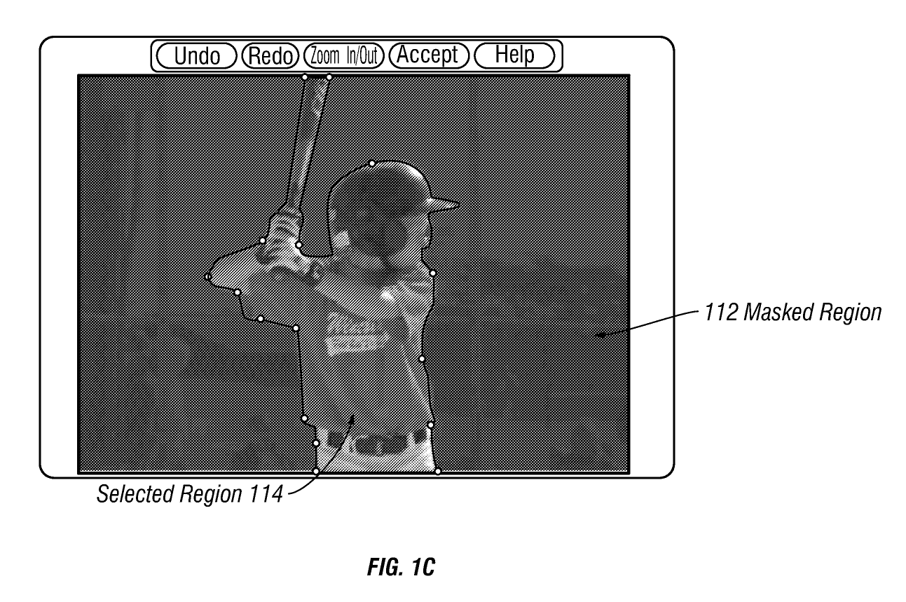

FIG. 1A is a screen capture of a source image as presented by an exemplary image customization utility according to one embodiment of the present invention. As shown by the figure, the screen includes a user interface 102 having a set of buttons 104, a source image 108 displayed within a viewable region (denoted herein as view port 107), and optionally, a text tip 106 for providing feedback to the user when a certain condition occurs (for example, when the user navigates his mouse pointer over one of the buttons 104 of the user interface 102, text describing that button's functionality may be displayed).

While the user interface 102 illustrated in FIGS. 1A-1C includes a number of buttons spanning horizontally across the top of a screen, persons skilled in the art will recognize that the user interface is not limited to the arrangement, configuration, or functionality of the exemplary user interface shown herein. A wide variety of controls may be utilized to interface with the configuration utility, including, without limitation, scroll bars, check boxes, drop-down menus, dials, radio buttons, windows, text-fields, sliders, etc. Additionally, embodiments of the present invention are not limited to hand-operated input peripherals such as a mouse, trackball, touch sensor panel, keyboard, and/or joystick. For example, in some embodiments, voice activated or motion activated controls may be used provide input to the image customization utility. In other embodiments, a locally or remotely accessible file or data stream may be used as input to the image customization utility.

The source image 108 may contain any image or set of images which the user wishes to include within the printed substrate. In some embodiments, for example, the user may overlay or merge one or more images (including other images, shapes, text appearing in various fonts, stencils, clip-art, etc.) with a background image, thereby creating a customized composite image. In some embodiments, the image customization utility includes conventional image editing functionality such as scaling or rotating an image, flipping an image horizontally or vertically, image cropping, blurring a portion of the image, softening or sharpening edges, undo, redo, image zooming, transparencies, and other such image editing features.

By clicking upon a particular coordinate of the source image, the user can create an anchor point—one of several points that define a cut-path for the source image. In some embodiments, each anchor point added by the user in this manner is automatically connected to the previous anchor point, thereby forming a path upon the source image. One or more edge detection and/or path optimization algorithms (discussed subsequently) can be utilized in order to create an optimized path from the current anchor point to the previous one. The edge detection and/or path optimization algorithms may use color data (for example, RGB values) associated with particular pixels within the image and/or one or more specified tolerance levels in order to generate a particular path. In some embodiments, the user has the option of turning off the edge detection algorithm if the user instead wishes to create a straight path between successive anchor points 110.

In order to enable the user to have finer control over positioning each of the anchor points, in some embodiments, the view port 107 will display a zoomed-in portion of the source image 108 that is centered upon the last anchor point 110 selected. For example, FIG. 1B is a screen capture of a zoomed-in region of the source image depicted in FIG. 1A. As shown by the figure, the view port 107 is zoomed-in and centered around the most recently added anchor point 110 designated by the user (in this case, the lowest of the three anchor points 110 appearing in FIG. 1B). In some embodiments, when the user selects a new anchor point, the view port will re-center itself accordingly.

Note that while the anchor points 110 are depicted as circles in FIG. 1B, with colored line segments 111 connecting successive anchor points 110, a wide variety of means of may be used to indicate the anchor points 110 and the line segments according to embodiments of the present invention. In some embodiments, the color of the anchor points 110 and/or line segments 111 may depend upon color data of a pixel or a color average of a set of pixels that are overlaid by the anchor points 110 and/or line segments 111, thus enabling a user to have a clearer presentation of the cut path. For example, white or yellow indicators may be used over dark regions of the source image 108, while black or purple indicators may be used over light regions of the source image 108.

In some embodiments, if a user is unsatisfied with the path of a particular line segment 111, he may click on a particular pixel of the line segment and drag the mouse over a new region of the source image 108. In this manner, a new anchor point 110 can be created where the user releases (i.e., between the most recently added anchor point 110 and the previously added anchor point 110). The original line segment connecting the most recently added anchor point 110 and the previously added anchor point 110 will then be replaced by two line segments: a line segment 111 between the previously added anchor point 110 and the new intermediary anchor point 110, and a line segment 111 between the new intermediary anchor point and the most recently added anchor point 110.

Note that in some embodiments, the path creation utility may enforce a number of constraints on the selection of anchor points 110 and line segments 111. For example, in some embodiments, the path between the most recently added anchor point 110 and the previously added anchor point 110 must not traverse a previously generated path. In some embodiments, edge detection algorithms and/or path optimization algorithms (discussed subsequently) may use previous path data in order to select a path which satisfies these constraints.

Also, in some embodiments, in order to ensure the mechanical operability of cutting apparatus, the angle of any given line segment 111 in a particular path must not exceed certain predetermined tolerances. Additionally, paths may not contain more than one anchor point for a specified distance (for example, 0.33 linear inches). In the event that the user-provided input violates one or more of the aforementioned constraints, error messages can be displayed to the user.

In some embodiments, the cut path may be completed after the user selects the first anchor point in the cut path as the next anchor point. After such a condition occurs, the portion of the source image 108 that has not been selected by the user (i.e., the portion of the source image which is not contained within the perimeter of the anchor points 110 and line segments 111) may be dimmed, blacked out, or grayed out as displayed in the view port 107. For example, FIG. 1C is a screen capture of the source image depicted in FIG. 1A, the source image having both a selected region 114 and a masked region 112 according to one embodiment of the present invention. As shown by FIG. 1C, the selected region 114 is bounded by an outline of the subject in the image as defined by a plurality of line segments 111 and anchor points 110, while the masked region 112 may include all of the pixels that have not been bounded by such an outline.

In some embodiments, multiple, non-contiguous regions 114 may be selected within the same source image 108. For example, suppose the image depicted in FIGS. 1A-1C also included a baseball positioned some distance away from the batter. After completing the outline of the batter, the user could then create an outline of the baseball in the same manner, thus creating multiple selected regions 114 for the same source image 108.

Similarly, according to some embodiments, a user may trace a certain sub-region of a selected region 114 in order to designate that area as a masked region 112. For example, if the selected region 114 were instead that of a donut, the user could trace the perimeter of the hole in order to mask this particular region.

In some embodiments, the path creation utility may treat any enclosed paths drawn within positive space (e.g., a selected region 114) as negative space (e.g., a masked region 112), and treat any enclosed paths drawn within negative space (e.g., a masked region 112) as positive space (e.g., a selected region 114). Additionally, in some embodiments, positive and negative space can be inverted (for example, via a button 104 on the user interface 102). This can be used, for example, to mask regions previously selected 114, or to select regions previously masked 112.

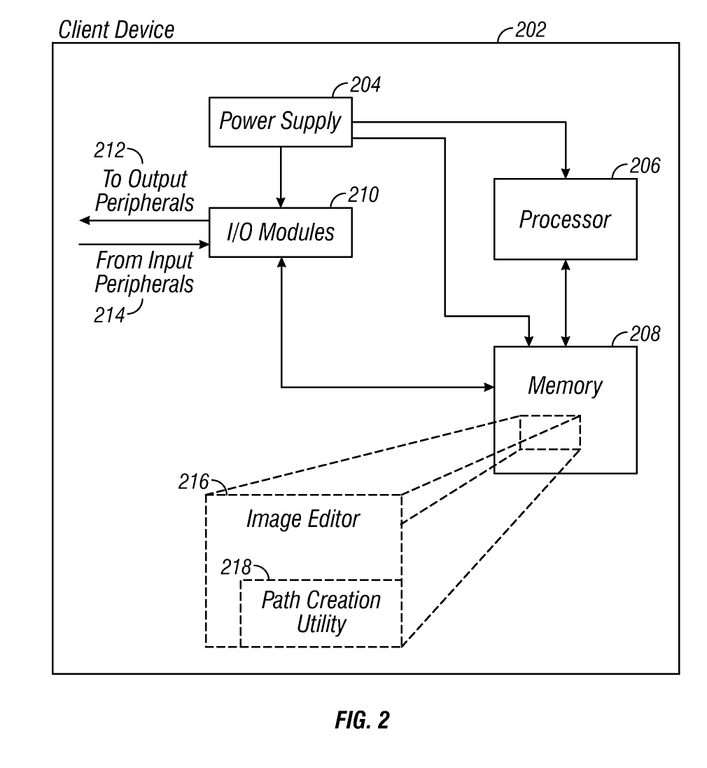

FIG. 2 is a block diagram of an exemplary client device 202 configured for use with the path creation 218 utility according to one embodiment of the present invention. As shown by the figure, the client device 202 includes a power supply 204, a processor 206, memory 208 including image editor 216 and path creation utility 218, and a number of I/O modules 210 adapted to interface with input 212 and output peripherals 214 (not shown).

A power supply 204 provides a source of power to the various modules disposed within the client device 202. In some embodiments, power is supplied externally by one or more conductive wires, for example, from a power cable or a serial bus cable. In other embodiments, a battery may be used as a source of power.

Memory 208 comprises any type of module adapted to enable digital information to be stored, retained, and retrieved. Such memory 208 may comprise any combination of volatile and non-volatile storage devices, including without limitation RAM, DRAM, SRAM, ROM, and/or flash memory. Memory 208 may also be organized in any number of architectural configurations utilizing, for example, registers, memory caches, data buffers, main memory, mass storage, and/or removable media.

One or more processors 206 are adapted to execute sequences of instructions by loading and storing data to memory 208. Possible instructions include, without limitation, instructions for data conversions, formatting operations, communication instructions, and/or storage and retrieval operations. Additionally, the one or more processors 206 may comprise any type of digital processing devices including, for example, reduced instruction set computer processors, general-purpose processors, microprocessors, digital signal processors, gate arrays, programmable logic devices, reconfigurable compute fabrics, array processors, and/or application-specific integrated circuits. Note also that the processors 206 may be contained on a single unitary IC die or distributed across multiple components.

A set of I/O modules 210 may be used to interface with, communicate with, drive, or control a set of external I/O peripherals (not shown) in communication with the client device 212. Exemplary input peripherals 212 include, without limitation, keyboards, mice, trackballs, touch sensor panels, motion sensors, and microphones. Exemplary output peripherals 214 include, without limitation, display screens, monitors, terminals, televisions, speakers, printers, serial bus ports, and mass storage devices.

An image editor 216 resident within memory 208 may be utilized in order to enable a user to perform conventional image editing functionality with respect to one or more loaded images. Such functionality may include scaling or rotating an image, flipping an image horizontally or vertically, image cropping, blurring a portion of the image, softening or sharpening edges, undo, redo, image zooming, transparencies, and other such features.

As shown by FIG. 2, the image editor 216 may also include a path creation utility 218 configured to enable a user to custom cut paths overlaying a portion of one or more of the loaded images. The custom cut paths may then be provided to a mechanical cutting device configured to cut one or more selected regions from a printed copy of the source image, thereby creating a printed substrate having a user-specified geometry. Note that the copy of the source image may be scaled to a large format before being printed and cut according to some embodiments of the present invention. Also, according to some embodiments, the substrate may include at least one adhesive surface, thereby enabling the substrate to be adhered to a target surface.

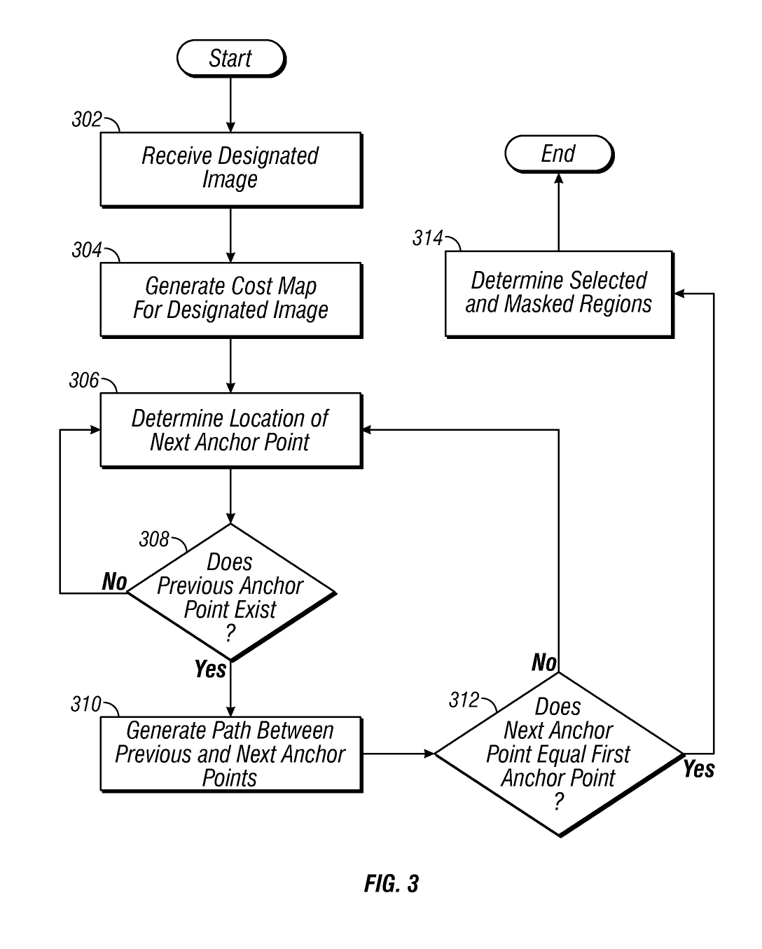

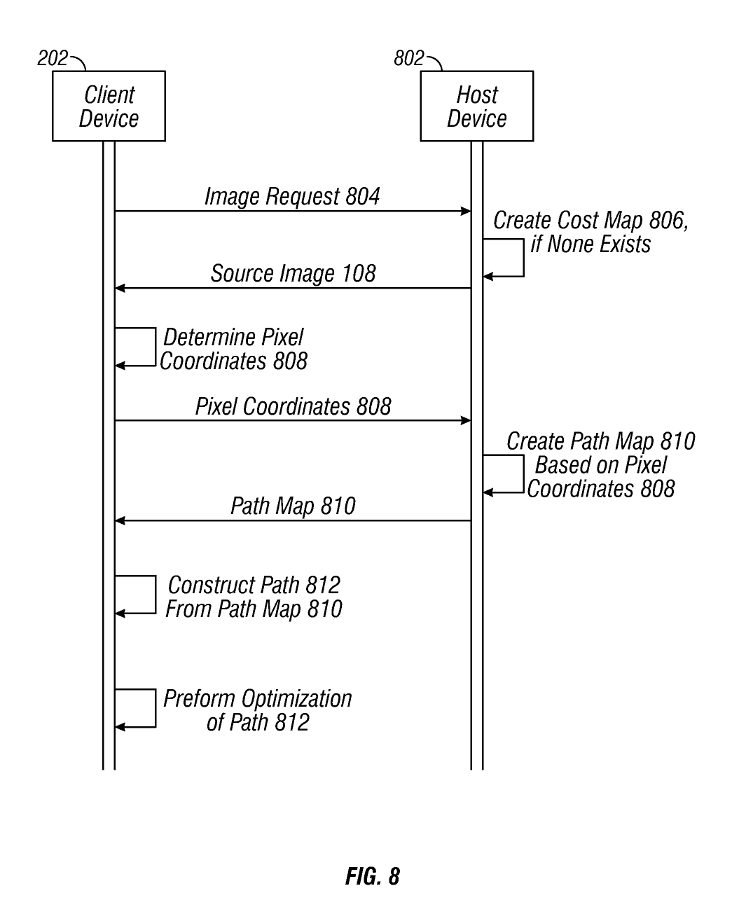

FIG. 3 is a flow diagram illustrating an exemplary method of generating a user-defined cut-path according to one embodiment of the present invention. Note that for purposes of promoting readability, network interactions between a client and a host device have been omitted from this figure. Persons of ordinary skill in the art will recognize, however, that some or all of the steps depicted in FIG. 3 may be performed by a client and a host device connected over a network (for example, as described subsequently with respect to FIG. 8). Alternatively, a single client device may be utilized to perform some or all of the steps illustrated in this figure.

At block 302, a designated image is received. The image may be stored and/or compressed in a variety of file formats, including, without limitation, graphic interchange format (gif), joint photographic expert group (jpeg), bit-map (bmp), personal computer exchange (pcx), portable network graphic (png), and tagged image file format (tiff). In some embodiments, the designated image may be retrieved from a remote server, for example, via a network connection. In other embodiments, the designated image may be retrieved from a local memory source.

At block 304, a cost map may be generated for the received image, if such a map does not already exist. The cost map is a data structure which may be used in order to determine the costs of traversing from a given pixel to any neighboring pixel.

In some embodiments, the cost map includes a header indicating the pixel width and pixel height of the map, as indicated in respective 16-bit words. For each pixel of the source image, the costs of traveling from the instant pixel to one of eight neighboring pixels (e.g., to the pixel positioned above, below, or to the right or left of the instant pixel, or to the pixel situated diagonally in the upper-left, upper-right, lower-left, and lower-right positions) is provided within the cost map. Thus, each pixel may have eight bytes of corresponding data, where each byte indicates the cost of traveling from the instant pixel to one of eight possible directions.

In some embodiments, cost values are in the range of 0-254, with a special value reserved to indicate an image boundary or infinite cost (e.g., 255). Use of the special value can substantially cut down processing time during path calculation, as paths may not travel in the directions that have been assigned this special value.

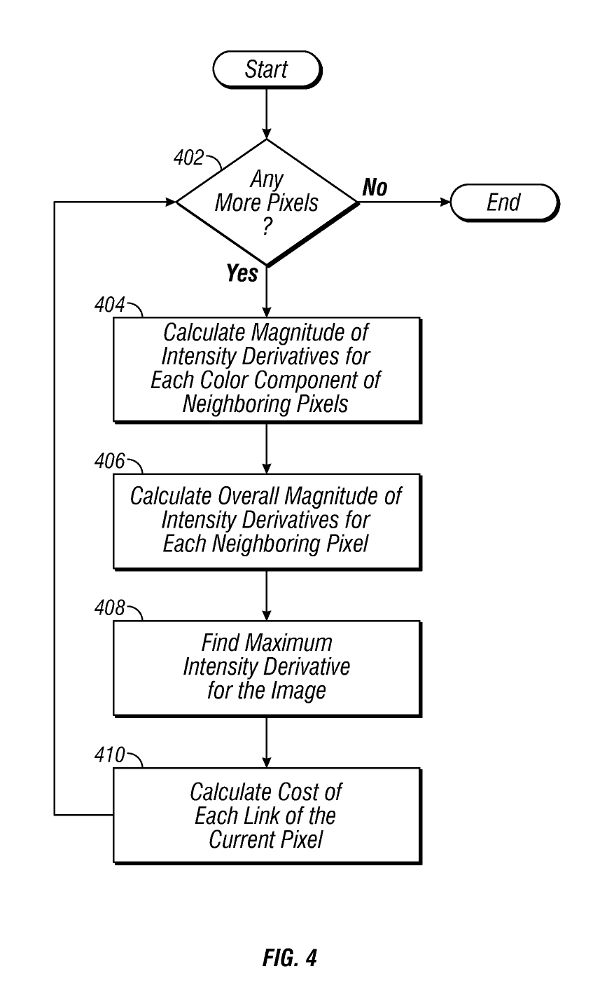

A wide variety of cost functions may be utilized in order to assign costs to each direction of a pixel according to embodiments of the present invention. In some embodiments, for example, cost values may be based upon a magnitude of intensity derivative (i.e., a value that is based on the respective R, G, and B color components of one or more pixels situated adjacent or relatively proximate to the current pixel). An exemplary cost function which utilizes the magnitude of intensity derivative mentioned above is described subsequently (see FIG. 4 and accompanying text).

At block 306, the location of the next anchor point is determined. The location of the next anchor point can be provided as (x,y) coordinates according to some embodiments, and may be determined, for example, by identifying a particular pixel selected by the user.

At block 308, a decision is made as to whether a previous anchor point exists (i.e., an anchor point which is not already included within a bounded trace path). If a previous anchor point does not exist, then this is the first anchor point of a new cut path, and hence no path connecting this anchor point to a previous anchor point needs to be generated. The process then resumes at block 306.

On the other hand, if a previous anchor point does exist, then at block 310, a path is generated between the previous anchor point and the present anchor point. The path may be determined from one or more path maps stored within memory or transferred from a remote module, where each path map indicates an optimal path from any point in the image to a particular destination or “seed” point (in this case, an anchor point). The path maps, in turn, may be based upon the various cost values stored within the cost map, thereby enabling an optimal path between the current anchor point and the previous anchor point to be determined. For example, in one embodiment, an optimal path between two points may refer to the path formed by the continuous chain of pixels between the two points which has a sum of costs that is less than or equal to the sum of costs between pixels forming any other continuous chain. Note that the method described above is merely exemplary in nature; myriad other methods for accomplishing path generation may be utilized according to the scope of the present invention.

In some embodiments, each path map may consist of a number of values in the range 0-8 (one such value per each pixel of the image), where each value indicates the optimal direction to take in order to reach the seed point from that pixel. In one embodiment, the values “0”-“7” may correspond respectively to each of the eight particular directions (right, left, lower-right, etc.) with the value “8” indicating the seed point itself (e.g., the ultimate destination). By repeatedly determining the direction to take from the current pixel to the next pixel in the path, the optimal path may from any point within the image to the seed point can therefore be constructed.

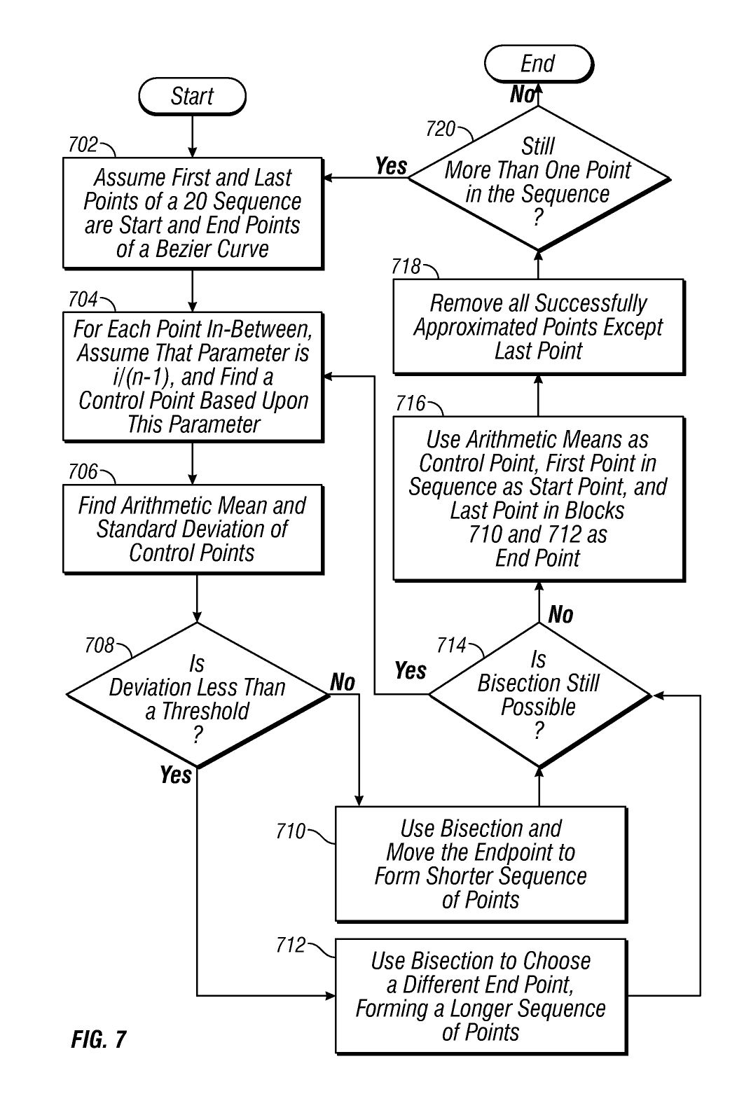

Optionally, in some embodiments, the paths generated may be passed to a point set optimizer and/or a Bezier curve fitting algorithm in order to reduce the number of path points and/or line segments between successive anchor points. An exemplary point set optimizer and Bezier curve fitting algorithm is discussed subsequently (see FIG. 7 and accompanying text).

At block 312, a determination is made as to whether the next anchor point is equal to the first anchor point. If the next anchor point is not equal to the first anchor point, then additional anchor points are to be added to the cut-path, and the process resumes at block 306. On the other hand, if the next anchor point is equal to the first anchor point, then selected and masked regions can be determined at block 314, thereby ending the process. Note that if a user wishes to designate additional cut-paths within the source image, the process can repeat per block 302, with the next anchor point serving as the first anchor point in the next path.

FIG. 4 is a flow diagram illustrating an exemplary cost function for generating a cost map according to one embodiment of the present invention. The cost function may be used, for example, to generate a cost map for determining optimal paths between successive anchor points (e.g., paths which propagate along edges of a particular subject in the image). In some embodiments, costs are proportional to magnitude of intensity derivatives. This can ensure, for example, that the path selected as an optimal path will propagate along the strongest edges of an image subject without crossing them.

At block 402, a determination is made as to whether any more pixels exist for which link costs (i.e., the costs of traveling in each of eight directions from the current pixel) have not yet been determined. If link costs have been calculated for each pixel of an image, the process ends. Otherwise, the next pixel for which link costs have not yet been determined is considered at block 404.

At block 404, magnitude of intensity derivates are calculated for each color component (i.e., separately for red, green, and blue components) for each of the eight pixels neighboring the present pixel. As stated above, a reserve value (e.g., 255) may be used to designate image boundaries or to indicate a direction with an infinite cost.

According to one embodiment, the magnitude of intensity derivative for each color component C (e.g., R, G, and B), to the pixels immediately above and below the current pixel (i,j) (assuming such pixels exists) may be calculated as follows:

$$Dc = \frac{\vert \frac{c ( i - 1 , j ) + c ( i - 1 , j - 1 )}{2} - \frac{c ( i + 1 , j ) + c ( i + 1 , j - 1 )}{2} \vert}{2}$$

where c(i,j) is the color component value (e.g., red, green, or blue) of the pixel (i,j).

The magnitude of intensity derivative for each color component C, to the pixels situated diagonally-adjacent to the current pixel (i.e., upper-left, upper-right, lower-left, and lower-right) (assuming such pixels exist) may be calculated as follows:

$$Dc = \frac{\vert c ( i + 1 , j ) - c ( i , j - 1 ) \vert}{\sqrt{2}}$$

The magnitude of intensity derivative for each color component C, to the pixels immediately to the right and to the left of the current pixel (assuming such pixels exist) may be calculated as follows:

$$Dc = \frac{\vert \frac{c ( i , j - 1 ) + c ( i + 1 , j - 1 )}{2} - \frac{c ( i , j + 1 ) + c ( i + 1 , j + 1 )}{2} \vert}{2 }$$

Once the magnitude of intensity derivatives for each color component of each link from the current pixel have been calculated, the process may continue per block 406.

At block 406, overall magnitude of intensity derivatives for each of the neighboring pixels is calculated. In one embodiment, the overall magnitude of intensity derivates may be calculated as follows:

$$D = \sqrt{\frac{( Dr * Dr ) + ( Dg * Dg ) + ( Db * Db )}{3}}$$

where Dr, Dg, and Db are intensity derivatives as calculated at block 404 for red, green and blue components, respectively.

At block 408, a maximum intensity derivative (MAX_D) for the image may then be determined. Note that in some embodiments, determining the maximum intensity derivative for the image may be implemented as part of block 406.

At block 410, a cost of each link from the current pixel is then calculated. In one embodiment, the cost of a given link is provided as follows:

COST(link)=(MAX_{—}D−D(link))*LINK_LENGTH

where MAX_D is the maximum intensity derivative calculated at block 408, D(link) is a magnitude of intensity derivative calculated at block 406, and LINK_LENGTH is equal to \sqrt{2} for diagonal links, and 1 for other links.

Note that link costs may be computed and/or stored within the map using single or double precision math (i.e. 32-bit or 64-bit floating point numbers), thus providing different trade-offs between processing speed and accuracy. Also, the mode or modes to be utilized may be selected at compile time according to some embodiments.

Also, in some embodiments, four costs may be written to the cost-map instead of eight, with “mirror” links being treated identically. In this manner, the size of the cost-map can be substantially reduced, yet the entire cost-map can still be read and restored in a single pass, with no pixel being visited more than once.

In some embodiments, costs may be normalized to the range of 0-254, with the highest valid cost value being 254. If a cost map builder is compiled in integer mode (i.e., with link costs being 4-byte integers), costs may be stored as 1-byte unsigned numbers, thereby reducing storage space and increasing overall performance.

Once a cost map has been generated, it can be stored within a remote server with a filename and/or file prefix corresponding to the image being edited. In this manner, if a second user wishes to create a different cut-path for the same image, instead of generating a new cost map, the cost-map already created can reused.

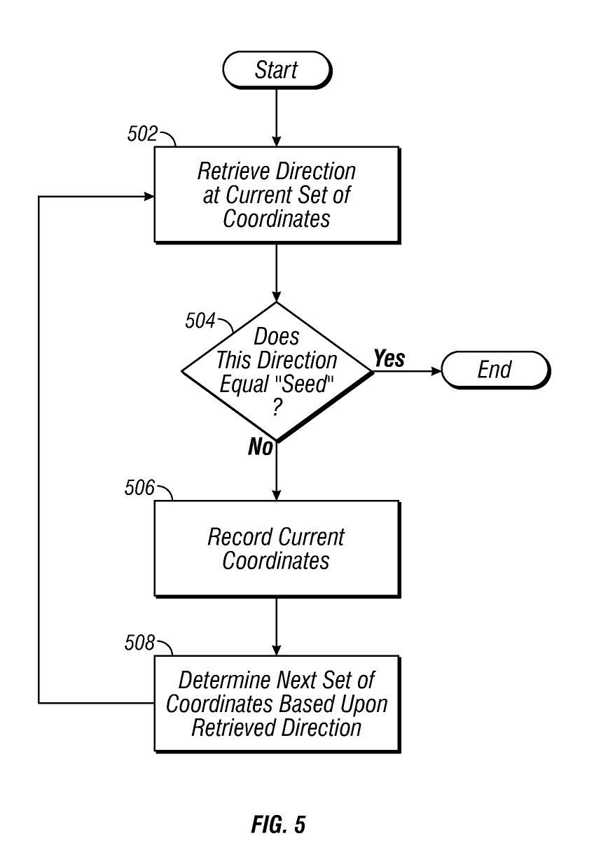

Path maps can then be created based upon the cost map, and paths constructed by iteratively determining the direction indicated at the current location until the seed point has been reached. For example, FIG. 5 is a flow diagram illustrating an exemplary process for calculating an optimal path between two points according to one embodiment of the present invention.

Suppose it is necessary to determine the “best” path from point A(i,j) to the seed point S(x,y). At block 502, the direction indicated at (i,j) is determined (for example, by reading a numeric value stored within a path map, where the value corresponds with the point having coordinates (i,j)). For the purposes of the present example, assume that this value is equal to “3”, with “3” indicating the direction “left” of the current pixel.

At block 504, a determination is made as to whether this direction equals “seed”. If so, the path has reached its destination, and the process ends. In the present example, the direction indicates “left” and not “seed”, so the process continues per block 506.

At block 506, the current coordinates are recorded. This can be accomplished, for example, by writing data indicative of the coordinates to a file or other data structure. Note that in some embodiments, values indicating directions (i.e., the numbers 0-8) are recorded instead of (x,y) coordinates. A myriad number of other methods may be used for indicating direction according to embodiments of the present invention.

At block 508, the next location in the path can then be calculated based upon the direction retrieved in block 502. In the present example, for instance, since the direction indicated was “left”, the next point in the path has the coordinates (i−1,j) (i.e., the pixel immediately left of the pixel with coordinates (i,j)). This process then repeats at block 502 until the direction retrieved is the “seed” (e.g., a direction with the value of “8”), at which point the end of the path has been reached. Optionally, the path generation algorithm may perform a “sanity check” by comparing the current coordinates (i,j) with the seed coordinates (x,y). If these values do not match, an error message can then be generated.

Performance can be increased if no checks are made as to the validity of the current coordinates or whether the ending coordinates equal the coordinates of the seed. Additionally, in some embodiments, path maps can be reused after being generated, thus further preserving computational resources.

Note that in some embodiments, one or more constructed paths may deviate from the edges of a particular subject in the image at certain locations. This may occur, for example, as a result of a misplaced point in the path which is determined to be some distance away from the edge of the subject. A result is this “peaking” phenomenon is that the path generated may erroneously “peak” up to the misplaced point, pulling back down to the edge at the next path section.

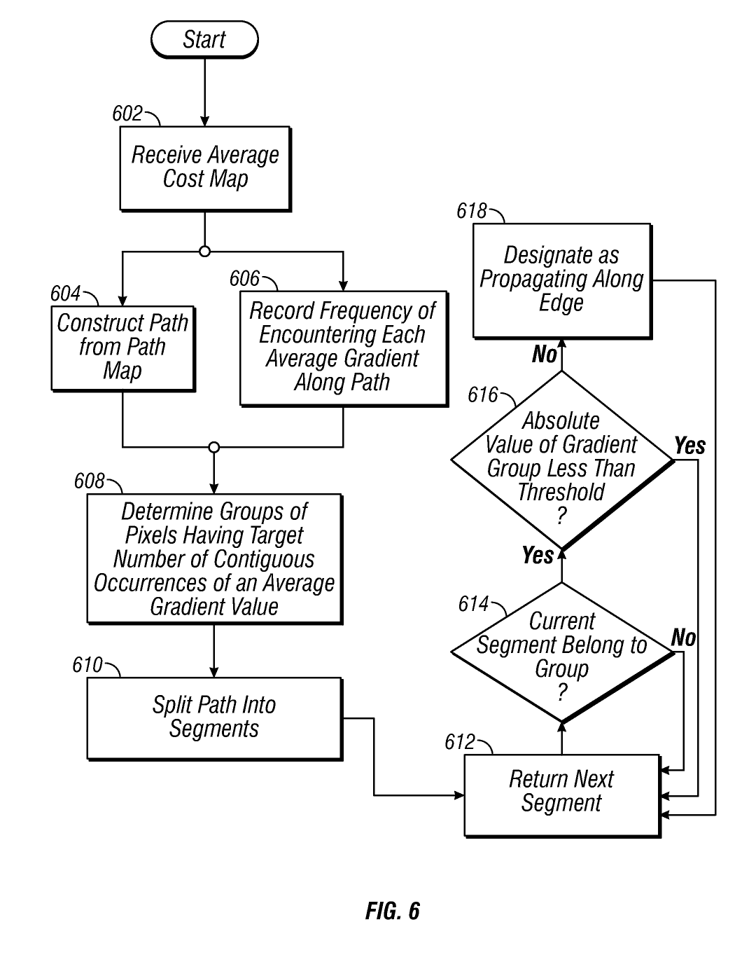

Such “peaking” may be reduced by applying one or more peak reduction algorithms before generating an optimized path. For example, FIG. 6 is a flow diagram illustrating an exemplary process for reducing the incidence of peaking within a path according to one embodiment of the present invention.

At block 602, an average cost map is received. The average cost map may be a file or other similar data structure that indicates the average of all gradients connected to each pixel in the cost map. In one embodiment, the average cost map is a grayscale GIF image containing one byte per pixel, where each pixel contains an average of all of the gradients connected to that respective pixel.

In some embodiments, the average cost map may be generated within a client device and received within a local memory unit. In other embodiments, the average cost map may be received from a remote device (for example, as transmitted from a host device along with one or more requested images).

While a pixel-by-pixel path is constructed from the path map (as shown at block 604), the frequencies of each average gradient value encountered along the path are recorded (block 606). In one embodiment, a histogram is generated to record such values, but various other data structures may be used in the alternative.

At block 608, groups of pixels are then determined which have a designated number of contiguous occurrences of a particular average gradient value. In one embodiment, each group contains five or more pixels and the designated number of contiguous occurrences is two or more. Note, however, that the values provided above are merely exemplary in nature; myriad other values for group size and for representing the number of contiguous occurrences of average gradient values may be used in the alternative. Individual entries and groups which do not satisfy these criteria may be omitted from consideration.

At block 610, the path is then split into segments: segments which consist of pixels belonging to one of the groups determined at block 608, and segments which do not. Then, at block 612, the next segment to be considered is returned. In one embodiment, the first such segment is the segment including the point where the most recently added anchor point was placed.

At decision block 614, if the segment does not belong to any group found at block 608, the segment is skipped, and the process continues per block 612. Otherwise, an absolute value of the gradient group is checked at block 616. If the absolute value is less than a predetermined threshold, then the segment is considered a non-edge and skipped, and the process then continues per block 612. Otherwise, the segment is designated as propagating along an edge at block 618, and the next segment is considered at block 612.

In this manner, paths which propagate along edges of a subject may be identified and separated from paths which do not propagate along such edges. The misplaced points in the paths which do not propagate along the edges may then be “snapped” or relocated back to the true edges of the subject, thereby yielding a path with reduced incidence of peaking.

In some embodiments, a number of optimization algorithms can be utilized in order to reduce the number of path points and/or segments situated within a cut path or between successive anchor points. Such optimization algorithms may be used, for example, to smooth out a given path, to fit a given set of points within one or more arcs, or to otherwise reduce the number of “staircase pattern” segments which tend to be created for strong straight vertical and horizontal edges appearing within a particular image.

In one embodiment, “staircase patterns” may be eliminated by traversing a path map while building a path point sequence according to a point set optimization algorithm. Note that while an exemplary point set optimization algorithm has been provided below (in pseudo-code), a wide variety of optimization and/or post-processing algorithms may be utilized for these or similar purposes.

As presented in the exemplary point set optimization algorithm that follows, the path constructed is from a point P to seed:

```
SET P to current coordinates on the map
SET PREV_D to “invalid”
LOOP
    RECORD(P)
    SET D to DIRECTION_AT(P)
    IF D is “right-up”
        SHIFT P “right-up”
        IF PREV_D is “up” AND DIRECTION_AT(P) is “up-left”
        SET D to “up”
        SHIFT P “left”
        RECORD(P)
        SHIFT P “up”
        ELSE IF PREV_D is “right” AND DIRECTION_AT(P) is
    “right-down”
        SET D to “right”
        SHIFT P “down”
        RECORD(P)
        SHIFT P “right”
    ELSE IF D is “up”
        SHIFT P “up”
    ELSE IF D is “up-left”
        SHIFT P “up-left”
        IF PREV_D is “up” AND DIRECTION_AT(P) is “right-up”
        SET D to “up”
        SHIFT P “right”
        RECORD(P)
        SHIFT P “up”
        ELSE IF PREV_D is “left” AND DIRECTION_AT(P) is “left-
    down”
        SET D to “left”
        SHIFT P “down”
        RECORD(P)
        SHIFT P “left”
    ELSE IF D is “left”
        SHIFT P “left”
    ELSE IF D is “left-down”
        SHIFT P “left-down”
        IF PREV_D is “down” AND DIRECTION_AT(P) is
        “right-down”
        SET D to “down”
        SHIFT P “right”
        RECORD(P)
        SHIFT P “down”
        ELSE IF PREV_D is “left” AND DIRECTION_AT(P) is
        “up-left”
        SET D to “left”
        SHIFT P “up”
        RECORD(P)
        SHIFT P “left”
    ELSE IF D is “down”
        SHIFT P “down”
    ELSE IF D is “right-down”
        SHIFT P “right-down”
        IF PREV_D is “down” AND DIRECTION_AT(P) is
        “left-down”
        SET D to “down”
        SHIFT P “left”
        RECORD(P)
        SHIFT P “down”
        ELSE IF PREV_D is “right” AND DIRECTION_AT(P) is
    “right-up”
        SET D to “right”
        SHIFT P “up”
        RECORD(P)
        SHIFT P “right”
    ELSE IF D is “right”
        SHIFT P “right”
    ELSE IF D is “seed”
        DONE
    ELSE
        ERROR
    SET PREV_D to D
END LOOP
```

As the code above indicates, by specially processing the diagonal directions, a smoother path can be generated than the raw path created from following the path-map alone. Advantageously, this can reduce the number of “staircase patterns” propagating along horizontal or vertical edges of a particular subject in the image.

Note also that output from the point set optimization algorithm may be provided as input to a Bezier curve creator for further path optimization according to some embodiments of the present invention. This process can be used, for example, to approximate a sequence of two-dimensional points with longer segments having a minimal number of quadratic Bezier curves.

A quadratic Bezier curve is a parameterized equation which has a solution defined by a start point, an end point, a control point, and a parameter. Supplying different values of a parameter t yields different points belonging to the same Bezier curve. Thus, with a start point, an end point, a control point, and a parameter, a corresponding point on a Bezier curve can be determined.

Also, separate points on the same Bezier curve will each yield the same control point. Thus, with the start point, end point, parameter, and point on a curve, the control point of the curve can then be identified. By using this control point along with corresponding set of parameters, the entire curve can then be reconstructed.

However, since the parameter t is not usually known, and since path points may not lay exactly on a Bezier curve, some embodiments of the present invention identify a “theoretical” control point for each point in the two-dimensional sequence based on a set of assumptions. These assumptions may include, for example: i.) that the start and end points are always chosen from the two-dimensional points being approximated, and ii.) that the parameter t is proportional to the sequential number of a point in the list of points being approximated.

Thus, if the theoretical control points are sufficiently close together, a conclusion may be drawn that the assumptions were correct and the points are close to a Bezier curve. Conversely, if the calculated control points are far from each other, a conclusion may be drawn that the points do not form a Bezier curve. In this case, a new set of points is identified which better fits the aforementioned assumptions.

FIG. 7 is a flow diagram illustrating an exemplary process for Bezier curve generation for use in determining an optimal path according to one embodiment of the present invention. Note that the original two-dimensional set of points may be required to form a contiguous line, with the distance between any two adjacent points not exceeding one pixel along any axis.

At block 702, the first and last points of a two-dimensional sequence are assumed to be the start and end points of a Bezier curve to find. Then, for each point situated in-between (as shown at block 704), the parameter t is assumed to be i/(N−1), where i is a sequential number of the current point in the list, and N is the total number of points in the list. Based upon the start point, end point, current point, and the assumed parameter t, the control point of the corresponding Bezier curve can then be calculated.

At block 706, the arithmetic mean and standard deviation are calculated for each of the control points. Next, a comparison is made at block 708 as to whether the standard deviation is less than a predetermined threshold. If the standard deviation is determined to be less than a predetermined threshold, then bisection may be used to select a different end point forming a longer sequence of points (block 710). However, if the standard deviation is determined not to be less than the predetermined threshold, then bisection may be used to move the end point so as to form a shorter sequence (block 712).

Next, at block 714, a determination is made as to whether bisection is still possible. If so, the process repeats per block 704. Otherwise, a portion of the initial sequence has been successfully approximated. Then, at block 716, the arithmetic mean found at block 706 is used for the approximated curve's control point, with the first point of the sequence serving as the curve's start point, and the last point found in blocks 710 and 712 serving as the curve's end point.

At block 718, all successfully approximated points may be removed except for the last point, which will serve as the start point of the next curve to preserve contiguity. A comparison can then be made at block 720 as to whether more than one point still exists in the sequence. If so, the process may repeat per block 702. Otherwise, the generation of Bezier curves has been successfully completed, and the process ends.

FIG. 8 is a sequence diagram illustrating an exemplary sequence for generating a user-defined cut-path using a network application according to one embodiment of the present invention.

A user of an image editor resident within the client device 202 may begin by selecting an image 108 that is accessible to the host device 802. The image 108 may be stored within the host device 802 itself or otherwise within a remote storage module (e.g., a module that is accessible to the host device 802 via a network or serial bus connection). Alternatively, the image specified may be stored locally within the client device 202 and uploaded to the host device 802. Once the image 108 has been designated by the user, an image request 804 can then be sent to the host device 802.

Upon receipt of the image request 804 by the host device 802, the host device 802 may then generate a cost map 806 if such a map 806 has not been already generated. Optionally, if the total number of cost maps 806 already generated exceeds a specified value (e.g., a predetermined map cache size), the earliest cost map 806 within the host device 802 can be deleted before the new cost map 806 is created.

In some embodiments, once the cost map 806 has been created for a particular image 108, the map 806 may then be stored locally so that it can be used for subsequent operations (e.g., such as operations initiated by other users/client devices 202 on the same network).

A copy of the requested image 108 can then be transferred to the client device 202, if not already present. Note that in the embodiment depicted by FIG. 8, the cost map 806 is never transferred to the client device 202, thereby enabling it to be reused by other client devices 202. However, in alternative embodiments, a copy of the cost map 806 can be transferred to the client device 202. This may be useful, for example, if the path creation utility on the client device 202 is itself capable of generating path maps 810. In certain cases, generating path maps 810 at the client device 202 instead of the host device 802 can preserve computational and/or network resources (e.g., bandwidth) associated with the host device 802.

The path creation utility then determines the pixel coordinates 808 of the next anchor point based upon a selection made by the user (for example, when the user has clicked on a particular pixel of the source image 108, or when the user has dragged a certain line segment to a particular pixel of the source image 108).

The coordinates 808 of the pixel determined are then transferred to the host device 802. Optionally, the data transferred to the host device 802 may also include the X and Y coordinates of the top-left corner of the image currently visible to the user, as well as the width (Dx) and Height (Dy) of the area currently visible to the user. In certain cases, specifying a sub-region of the image 108 in this manner can serve to reduce the number of calculations necessary for generating the path-map, as the current anchor point can be assumed to fall within a certain range of the previous anchor point.

Upon receipt of the pixel coordinates 808, the host device 802 can then generate a path map 810 using, for example, the provided pixel coordinates 808 as a seed point. In some embodiments, the path map 810 may include an image (e.g., a GIF or PNG file) with pixel values in the range of “0”-“8”, where the values “0”-“7” represent directions to the next pixel in the path, and where the value “8” refers to the seed itself. A myriad number of other file formats and or data structures may be used to represent the path map 810 according to embodiments of the present invention.

The host device 802 can then transfer the path map 810 to the client device 202. In some embodiments, a copy of the path map 810 may be stored within the host device 802. In other embodiments, a copy of the path map 810 may be stored within a storage module accessible to the host device 702 (not shown).

Upon receiving the path 810 map at the client device 202, a path 812 may then be generated between successive anchor points, or to an intermediary anchor point positioned between successive anchor points. Optionally, any paths 812 so constructed may be fed into one or more optimization algorithms in order to reduce the number of path points and/or to smooth out paths between anchor points. The optimization algorithms described above can be used for this purpose (see, e.g., FIG. 7 and accompanying text).

Once the paths 812 have been constructed and/or optimized, these paths 812 may be then provided as input to an external cutting module. The external cutting module (not shown) can then cut the paths specified from a printed copy of the source image 108. In some embodiments, the source image 108 (and corresponding paths 812) may be scaled to a larger or smaller format before the cutting occurs. According to some embodiments, the substrate may include at least one adhesive surface, thereby enabling the substrate to be adhered to a target surface.

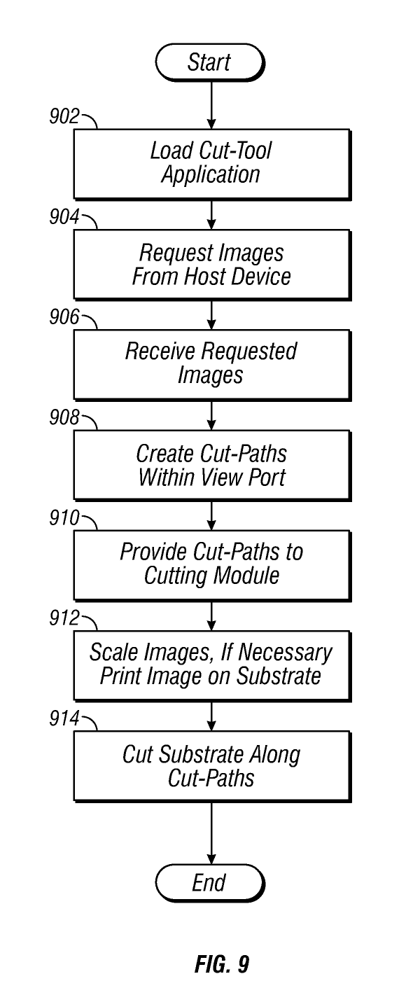

FIG. 9 is a flow diagram illustrating an exemplary process of creating a printed substrate having dimensions based upon one or more provided cut-paths according to one embodiment of the present invention.

At block 902, a cut-tool application is loaded into memory. The cut-tool application may be a component of an image editor or other such utility, an add-on or plug-in, or a standalone application according to various embodiments of the present invention.

At block 904, images are requested from a host device. In some embodiments, the images may be stored within a device that is remotely accessible to the host device. The requested images may then be transferred to the host device and then to the client device, or directly to the client device in the alternative.

At block 906, the requested images are received. The images may be received within the client device and presented within a view port that is displayed to one or more users. In some embodiments, the requested images can be manipulated, edited, rotated, scaled, overlayed, flattened, and/or merged, thereby creating one or more composite images.

At block 908, a user may create cut-paths within the view port. This may be accomplished, for example, by designating a series of anchor points over one or more specific regions of an image. In some embodiments, with each new anchor point added, the cut-tool application will generate a path to the prior anchor point. In other embodiments, the cut-path may be created as soon as all anchor points in the path have been designated.

At block 910, the designated cut-paths may then be provided to a cutting module. Optionally, one or more images (or image-related data) may also be transferred to the cutting module. In some embodiments, the cutting module is situated remotely from the client device (for example, a cutting device located at a remote image processing facility). In other embodiments, the designated cut-paths may be transferred to a local cutting module (for example, a module connected to a client device running the cut-tool application).

At block 912, the images may be scaled if a specific size format has been specified. All or a portion of a specified image can then be printed on a substrate. A wide variety of materials may be used for the substrate, including, without limitation, paper, cardboard, poster board, foil, fabrics, leather, wood, metal, glass, etc. Optionally, the substrate may include at least one adhesive surface in order to facilitate adhesion of the substrate to a target surface.

At block 914, the cutting module may then cut the substrate along the designated cut-paths (or alternatively, along scaled-up or scaled-down versions of the designated cut paths). A wide variety of cutting devices may be used for this process, including, without limitation, mechanical blades, etches, lasers, chemical substances, as well as thermal treatment. An adhesive layer or coating may be applied to a portion of the substrate before or after being cut according to some embodiments.

Although the present invention has been fully described in connection with embodiments thereof with reference to the accompanying drawings, it is to be noted that various changes and modifications will become apparent to those skilled in the art. Such changes and modifications are to be understood as being included within the scope of the present invention as defined by the appended claims.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An apparatus for defining a cut-path within a designated image, the apparatus comprising:
a memory unit adapted to store a set of instructions;
a processor connected to the memory unit and adapted to execute the set of instructions stored within the memory unit;
a first module in communication with the memory unit and adapted to determine a next point within a cut-path; and
a second module in communication with the memory unit and adapted to generate a path from a previous point in the cut-path to the next point in the cut-path, wherein the path generated is based at least in part upon a path map, and wherein the path map indicates, for each of a plurality of pixels represented within the path map, a specified direction from each respective pixel to the next point in the cut-path.

2. The apparatus of claim 1, wherein the first module is adapted to determine the next point within the cut-path based upon user-input.

3. The apparatus of claim 1, further comprising a communication module connected to the memory unit and adapted to receive the path map from a remote device.

4. The apparatus of claim 1, further comprising a third module in communication with the memory unit and adapted to reduce the number of staircase patterns propagating along horizontal or vertical edges appearing within the cut-path of the designated image.

5. The apparatus of claim 1, further comprising a third module in communication with the memory unit and adapted to determine a Bezier curve approximation for a set of points situated between the previous point in the cut-path and the next point in the cut-path.

6. The apparatus of claim 1, further comprising a third module in communication with the memory unit and adapted to reduce the incidence of peaking within the cut-path.

7. An apparatus for enabling a remote device to define a cut-path within a designated image, the apparatus comprising:
a memory unit adapted to store a set of instructions;
a processor connected to the memory unit and adapted to execute the set of instructions stored within the memory unit;
a communication module connected to the memory unit and adapted to transmit a requested image to the remote device; and
a first module in communication with the memory unit and adapted to generate a cost map for the requested image, wherein the cost map indicates, for each of a plurality of pixels contained within the requested image, costs of traversing from each respective pixel to each of its neighboring pixels.

8. The apparatus of claim 7, wherein the cost map is based at least in part upon color data associated with one or more pixels of the requested image.

9. The apparatus of claim 8, wherein the cost map is based at least in part upon one or more magnitude of intensity derivatives determined from the color data.

10. The apparatus of claim 7, wherein a reserve cost is used to indicate an image boundary within the requested image.

11. The apparatus of claim 7, wherein the communication module is further adapted to transmit the cost map to the remote device.

12. The apparatus of claim 7 further comprising a second module in communication with the memory unit and adapted to generate a path map based at least in part upon the cost map and a location specified by the remote device, wherein the path map indicates, for each of a plurality of pixels represented within the path map, a specified direction from each respective pixel to the next point in a path leading to the location.

13. The apparatus of claim 12, wherein the second module is adapted to generate the path map by determining, for each pixel represented within the path map, the sequence of pixels between that respective pixel and the location having the smallest sum of costs.

14. The apparatus of claim 12, wherein the communication module is further adapted to transmit the path map to the remote device.

15. A method for use in a host device, the method for enabling a client device
to define a cut-path within a designated image, the method comprising:
receiving a first set of data from the client device, the first set of data adapted to
indicate a designated image;
generating a cost map for the designated image, wherein the cost map is adapted to indicate, per each pixel of the designated image, a cost for each pixel of a set of neighboring pixels;
receiving a second set of data from the client device, the second set of data adapted to indicate a location of a current anchor point;
creating a path map based at least in part upon the location of the current anchor point and the cost map, wherein the path map is adapted to indicate a path between the current anchor point and a previous anchor point; and
transmitting the path map to the client device.

16. The method of claim 15, wherein the cost map is based at least in part upon color data associated with one or more pixels of the designated image.

17. The method of claim 16, wherein the cost map is based at least in part upon one or more magnitude of intensity derivatives determined from the color data.

18. The method of claim 15, wherein the second set of data comprises the coordinates of a pixel.

19. The method of claim 15, wherein the path map is created by selecting a minimum cost path as determined from one or more costs indicated within the cost map.

20. A computer-readable medium for use in a host device, the computer readable medium comprising instructions which, when executed by the host device, performs the method described in claim 15.

21. A computer-readable medium for use in a client device, the computer readable medium comprising instructions which, when executed by the client device, performs a process comprising:
transmitting an identifier to a host device, wherein the identifier is adapted to indicate a selected image;
receiving the selected image from the host device;
determining a location of a current anchor point from a first input;
transmitting the location of the current anchor point to the host device;
receiving a path map from the host device, wherein the path map is adapted to indicate, for each of a plurality of pixels represented within the path map, a specified direction from each respective pixel to the next point in a path leading to current anchor point; and
generating a path from a previous anchor point to the current anchor point based at least in part upon the path map.

22. The computer-readable medium of claim 21, wherein the process further comprises displaying a representation of the selected image within a view port after receiving the selected image from the host device.

23. The computer-readable medium of claim 22, wherein the process further comprises providing a zoomed-in view of a portion of the representation of the selected image, wherein the zoomed-in view is centered at the location of the current anchor point.

24. The computer-readable medium of claim 21, wherein the process further comprises determining a Bezier curve approximation for a set of points situated between the previous anchor point and the current anchor point.

25. The computer-readable medium of claim 21, wherein the process further comprises reducing the incidence of peaking occurring between the current anchor point and the previous anchor point.
